(19) United States
(12) Patent Application Publication
(10) Pub. No.: US 2025/0055235 A1
(43) Pub. Date: Feb. 13, 2025

(54) CABLE MODULE, CABLE MODULE MANUFACTURING METHOD, CIRCUIT BOARD ASSEMBLY, AND ELECTRONIC DEVICE

(71) Applicant: HUAWEI TECHNOLOGIES CO., LTD., Shenzhen (CN)

(72) Inventors: Tianming Liu, Dongguan (CN); Jianshuang Wen, Dongguan (CN); Jun Yu, Dongguan (CN)

(73) Assignee: HUAWEI TECHNOLOGIES CO., LTD., Shenzhen (CN)

(21) Appl. No.: 18/932,635

(22) Filed: Oct. 31, 2024

Related U.S. Application Data
(63) Continuation of application No. PCT/CN2023/089047, filed on Apr. 18, 2023.

(30) Foreign Application Priority Data
May 12, 2022 (CN) 202210514532.1

(51) Int. Cl. H01R 13/6597; H01R 12/75; H01R 43/24

(52) U.S. Cl. CPC H01R 13/6597; H01R 43/24; H01R 12/75

(57) ABSTRACT

A cable module includes a mating unit and a cable. The mating unit includes a plastic substrate and a transmission part. The transmission part includes a plurality of first signal terminal groups and a ground shielding part. The plurality of first signal terminal groups are disposed on a surface of the plastic substrate at intervals. The ground shielding part is insulated from the plurality of first signal terminal groups. The ground shielding part includes a plurality of ground terminals and an electrical connection structure. The plurality of ground terminals are disposed on the surface of the plastic substrate at intervals. One first signal terminal group is disposed between every two ground terminals. The electrical connection structure is embedded in the plastic substrate. The connection structure is fastened and electrically connected to the plurality of ground terminals, to connect the plurality of ground terminals in series to form a mesh structure.

### CROSS-REFERENCE TO RELATED APPLICATIONS

This application is a continuation of International Application No. PCT/CN2023/089047, filed on Apr. 18, 2023, which claims priority to Chinese Patent Application No. 202210514532.1, filed on May 12, 2022. The disclosures of the aforementioned applications are hereby incorporated by reference in their entireties.

### TECHNICAL FIELD

This application relates to cable technologies, and in particular, to a cable module, a cable module manufacturing method, a circuit board assembly, and an electronic device.

### BACKGROUND

In an information and communication technology (ICT) product including a device such as a server, a cable module is usually needed to connect different devices or parts, to implement signal transmission. The cable module usually includes a cable and a printed circuit board (PCB). The PCB is connected to the cable through electrical coupling, and a plurality of gold fingers configured to mate with a female connector are disposed on the PCB.

As a transmission rate increases, requirements on an insertion loss, crosstalk, signal integrity (SI), and the like of the ICT product are increasingly high. However, a frequently-used PCB cable module has a problem of poor crosstalk performance, affecting signal transmission quality of the cable module.

### SUMMARY

Embodiments of this application provide a cable module that can improve quality of signal transmission, a cable module manufacturing method, a circuit board assembly, and an electronic device.

According to a first aspect, this application provides a cable module, including a mating unit and a cable. The mating unit includes a plastic substrate and a transmission part. The transmission part includes a plurality of first signal terminal groups and a ground shielding part. The plurality of first signal terminal groups are disposed on a surface of the plastic substrate at intervals. The ground shielding part is insulated from the plurality of first signal terminal groups. The ground shielding part includes a plurality of ground terminals and an electrical connection structure. The plurality of ground terminals are disposed on the surface of the plastic substrate at intervals. One first signal terminal group is disposed between every two ground terminals. The electrical connection structure is embedded in the plastic substrate. The electrical connection structure is fastened and electrically connected to the plurality of ground terminals, to connect the plurality of ground terminals in series and form a mesh structure. The cable includes a plurality of first signal conductor groups and a plurality of ground conductors. Each ground conductor is electrically connected to one ground terminal correspondingly, and each first signal conductor group is electrically connected to one first signal terminal group correspondingly.

According to the first aspect, the electrical connection structure of the ground shielding part connects the plurality of ground terminals in series to form a mesh structure that is grounded together. This improves an electromagnetic shielding effect between the first signal terminal groups, and improves crosstalk performance of the cable module. Therefore, quality of signal transmission of the cable module is improved.

The plastic substrate is made of insulative plastics, and provides insulation protection for the plurality of first signal terminal groups and the ground shielding part.

According to the first aspect, in a first possible implementation of the first aspect of this application, the electrical connection structure includes a plurality of connection groups. The plurality of ground terminals are arranged along a first direction. A length of the ground terminal extends along a second direction different from the first direction. Every two ground terminals are fastened through one connection group. Each connection group includes a plurality of conductive connection parts that are arranged along a second direction at intervals. Each conductive connection part is connected between the two ground terminals.

Because the plurality of ground terminals are arranged along the first direction, and each connection group includes a plurality of conductive connection parts that are arranged along the second direction at intervals, the ground shielding part forms a plurality of regular grids. This facilitates manufacturing of the ground shielding part, and also facilitates dissipation of heat generated by terminals (including the first signal terminal, the ground terminal, and the like) in the cable module.

According to the first aspect or the first possible implementation of the first aspect of this application, in a second possible implementation of the first aspect of this application, each ground terminal includes a pad portion, a fastening portion, and a mating portion. The fastening portion is connected between the pad portion and the mating portion. The pad portion and a corresponding ground conductor are welded and electrically connected. Each conductive connection part is fastened between fastening portions of the two ground terminals. A recess is provided on a side wall of the fastening portion, and a side wall of the recess is fastened to the conductive connection part.

The ground terminal and the ground conductor are fastened through welding, which helps improve stability of electrical connection between the ground terminal and the ground conductor. The recess on the fastening portion helps adjust signal impedance of the cable module. Further, the quality of the signal transmission is improved.

According to the first aspect or the first and the second possible implementations of the first aspect of this application, in a third possible implementation of the first aspect of this application, in a third direction, at least a partial thickness of the pad portion is less than a thickness of the fastening portion, and/or at least a partial thickness of the mating portion is less than the thickness of the fastening portion. The third direction is different from the first direction, and the third direction is different from the second direction.

The thickness of the pad portion is less than the thickness of the fastening portion, and/or the thickness of the mating portion is less than the thickness of the fastening portion, to adjust the signal impedance, and further improve the quality of the signal transmission of the cable module.

According to the first aspect or the first to the third possible implementations of the first aspect of this application, in a fourth possible implementation of the first aspect of this application, the ground terminal further includes a bevel. The bevel is disposed on a circumferential edge that is of the mating portion and that faces away from the pad portion. The bevel is located on a side that is of the mating portion and that faces away from the inside of the plastic substrate. The plastic substrate covers the bevel, to prevent warpage of the ground terminal relative to the plastic substrate, and help improve flatness of a surface that is of the mating unit and on which the ground terminal is disposed. Further, contact stability is improved when the mating unit of the cable module is interconnected with a female connector.

According to the first aspect or the first to the fourth possible implementations of the first aspect of this application, in a fifth possible implementation of the first aspect of this application, a cavity is provided inside the plastic substrate, and is configured to adjust the signal impedance to improve the quality of the signal transmission of the cable module.

According to the first aspect or the first to the fifth possible implementations of the first aspect of this application, in a sixth possible implementation of the first aspect of this application, each first signal terminal group includes two first signal terminals. Each first signal conductor group includes two first signal conductors, and each first signal conductor is electrically connected to a corresponding first signal terminal. Two first signal terminals in each first signal terminal group may transmit a differential signal pair, to enable the cable module to adapt to a high-speed signal transmission scenario.

According to the first aspect or the first to the sixth possible implementations of the first aspect of this application, in a seventh possible implementation of the first aspect of this application, there are a plurality of ground shielding parts, so that layout flexibility is improved.

According to the first aspect or the first to the seventh possible implementations of the first aspect of this application, in an eighth possible implementation of the first aspect of this application, each first signal terminal group includes two first signal terminals, and the transmission part further includes a second signal terminal. The transmission part further includes a plurality of functional terminals. One functional terminal is disposed between every two adjacent ground shielding parts, and two second signal terminals are disposed between each functional terminal and an adjacent ground terminal. The cable further includes a plurality of functional signal conductors and a plurality of second signal conductors. Each functional signal conductor is electrically connected to one functional terminal correspondingly. Each first signal conductor group includes two first signal conductors. Each first signal conductor is electrically connected to a corresponding first signal terminal, and each second signal conductor is electrically connected to a corresponding second signal terminal.

For example, the two first signal terminals in each first signal terminal group may transmit the differential signal pair, to enable the cable module to adapt to the high-speed signal transmission scenario. The second signal terminal may transmit a low-speed signal. The functional terminal may transmit a power signal, and the like. In this way, a scenario in which the cable module may need to process the differential signal pair/the low-speed signal/the power signal.

In this application, a low speed and a high speed are only relative. For example, if a signal transmission rate of the second signal terminal is lower than a signal transmission rate of the first signal terminal, the second signal terminal transmits the low-speed signal, and the first signal terminal transmits a high-speed signal.

According to the first aspect or the first to the eighth possible implementations of the first aspect of this application, in a ninth possible implementation of the first aspect of this application, the plurality of ground terminals are arranged along the first direction. The length of the ground terminal extends along the second direction different from the first direction. There are two transmission parts. The two transmission parts are stacked along the third direction. The third direction is different from the first direction, and the third direction is different from the second direction. The plastic substrate includes two first insulators and one second insulator that are connected. The second insulator is located between the two first insulators along the third direction. The electrical connection structure of each transmission part is embedded in the first insulator. The ground terminals and the first signal terminal groups of each transmission part protrude from a surface that is of the first insulator and that faces away from the second insulator.

The ground terminals and the first signal terminals are disposed on both surfaces of the plastic substrate, which helps improve a transmission rate of the cable module. Two times of injection molding are performed to form the first insulator and the second insulator respectively, and the first insulator is formed by performing 1^{st}-time injection molding, so that terminals in the transmission part are supported by insulators. This can reduce a possibility that the terminals are deformed in the transmission part during the injection molding, and improve location precision and shape precision of the terminals in the transmission part.

According to the first aspect or the first to the ninth possible implementations of the first aspect of this application, in a tenth possible implementation of the first aspect of this application, a first snap-fit portion and a second snap-fit portion are disposed on each first insulator. A first snap-fit portion of the 1^{st} first insulator is snapped to a second snap-fit portion of the 2^{nd} second insulator, and a second snap-fit portion of the 1^{st} first insulator is snapped to a first snap-fit portion of the 2^{nd} first insulator. Because the two first insulators are fastened to each other, strength of the transmission part is improved.

According to the first aspect or the first to the tenth possible implementations of the first aspect of this application, in an eleventh possible implementation of the first aspect of this application, the cable module further includes a housing. The housing is fastened and sleeved outside the plastic substrate. A limiting protrusion bar is disposed on the surface of the plastic substrate, and the housing presses against the limiting protrusion bar. The limiting protrusion bar is configured to perform location fastening when the plastic substrate and the housing group are assembled, so that efficiency of assembling the cable module is improved.

According to the first aspect or the first to the eleventh possible implementations of the first aspect of this application, in a twelfth possible implementation of the first aspect of this application, the plurality of first signal terminal groups are arranged along the first direction. The housing includes a first side surface, a second side surface, a third side surface, a fourth side surface, a fifth side surface, and a sixth side surface that are connected. The first side surface and the second side surface are disposed opposite to each other along the second direction. The third side surface and the fourth side surface are disposed opposite to each other along the third direction. The fifth side surface and the sixth side surface are disposed opposite to each other along the first direction. A mating port extends from the first side surface to the fifth side surface. An insertion port is located on any one of the second side surface, the sixth side surface, the third side surface, and the fourth side surface, to enable the cable module to adapt to installation scenarios in different installation space, and improve wiring flexibility of the cable module.

According to a second aspect, this application provides a cable module manufacturing method, and the method includes the following steps:
performing injection molding on a transmission part to form a mating unit, where the mating unit includes a transmission part and a plastic substrate, the transmission part includes a plurality of first signal terminal groups and a ground shielding part, the plurality of first signal terminal groups are disposed on a surface of the plastic substrate at intervals, the ground shielding part is insulated from the plurality of first signal terminal groups, the ground shielding part includes a plurality of ground terminals and an electrical connection structure, the plurality of ground terminal are disposed on the surface of the plastic substrate at intervals, one first signal terminal group is disposed between every two ground terminals, the electrical connection structure is embedded in the plastic substrate, and the electrical connection structure is fastened and electrically connected to the plurality of ground terminals, to connect the plurality of ground terminals in series and form a mesh structure; and
fastening a cable to the mating unit, where the cable includes a plurality of ground conductors and a plurality of first signal conductor groups, each ground conductor is electrically connected to one end of the ground terminal correspondingly, and each first signal conductor group is electrically connected to one first signal terminal group correspondingly.

According to the second aspect, the electrical connection structure of the ground shielding part connects the plurality of ground terminals in series to form a mesh structure that is grounded together. This improves an electromagnetic shielding effect between the first signal terminal groups, and improves crosstalk performance of the cable module. Therefore, quality of signal transmission of the cable module is improved.

An injection molding process is performed to dispose the transmission part in the plastic substrate. This helps reduce a location tolerance of terminals (including the first signal terminal group and the ground terminal), a width tolerance of the terminals, and a shape tolerance of the mating unit. Further, a possibility of connecting the terminals in series when the mating unit is interconnected with the female connector is reduced, and reliability of using the cable module is improved.

According to the second aspect, in a first possible implementation of the second aspect of this application, the performing injection molding on a transmission part to form a mating unit includes:
performing 1^{st}-time injection molding on the transmission part to form a first preform, where the first preform includes the transmission part and a first insulator, the plurality of ground terminals and the plurality of first signal terminal groups are arranged on a surface of the first insulator along a first direction, a length of the ground terminal extends along a second direction different from the first direction, and the electrical connection structure is embedded in the first insulator; and
performing 2^{nd}-time injection molding on two first preforms stacked along a third direction, to form the mating unit, where the mating unit includes two first insulators, one second insulator, and two transmission parts, the second insulator is connected between the two first insulators, a plurality of ground terminals and a plurality of first signal terminal groups on each first insulator are disposed on a surface that is of the first insulator and that faces away from the other first insulator, the third direction is different from the first direction, and the third direction is different from the second direction.

The 2^{nd}-time injection molding is performed to form the mating unit, so that the first signal terminal groups and the ground terminals are disposed on two opposite surfaces of the mating unit, which helps improve a transmission rate of the cable module.

According to the second aspect or the first possible implementation of the second aspect of this application, in a second possible implementation of the second aspect of this application, the first signal terminal group includes two first signal terminals, and before the performing injection molding on a transmission part to form a mating unit, the manufacturing method further includes: providing a plurality of first signal terminal groups and a plurality of second signal terminals; providing a preformed mesh structure; and cutting the preformed mesh structure to form a plurality of ground shielding parts.

The preformed mesh structure is cut into the plurality of ground shielding parts, which facilitates use in different application scenarios.

According to the second aspect or the first and the second possible implementations of the second aspect of this application, in a third possible implementation of the second aspect of this application, the cutting the preformed mesh structure to form a plurality of ground shielding parts includes: cutting the preformed mesh structure to form the plurality of ground shielding parts and a plurality of power terminals. The performing injection molding on a transmission part to form a mating unit includes: disposing one functional terminal between every two adjacent ground shielding parts, and disposing two second signal terminals between each functional terminal and an adjacent ground terminal. The fastening a cable to the mating unit includes: electrically connecting each functional signal conductor to one functional terminal correspondingly, where the plurality of signal conductors include a first signal conductor and a second signal conductor, electrically connecting the first signal conductor to a corresponding first signal terminal, and electrically connecting the second signal conductor to a corresponding second signal terminal.

A same preformed mesh structure may be cut to obtain the functional terminal and the ground shielding part, which simplifies a manufacturing process of the cable module. Two first signal terminals in each first signal terminal group may transmit a differential signal pair, to enable the cable module to adapt to a high-speed signal transmission scenario. The second signal terminal may transmit a low-speed signal. The functional terminal may transmit a power signal. In this way, a scenario in which the cable module may need to process the differential signal pair/the low-speed signal/the power signal.

According to the second aspect or the first and the second possible implementations of the second aspect of this application, in the third possible implementation of the second aspect of this application, the providing a plurality of first signal terminal groups and a plurality of second signal terminals includes: performing copper alloy stamping to form the plurality of first signal terminal groups and the plurality of second signal terminals, and the providing a preformed mesh structure includes: performing the copper alloy stamping to form the preformed mesh structure.

The stamping is performed to form the first signal terminal group, the second signal terminal, and the preformed mesh structure, so that manufacturing costs of the cable module are reduced.

According to the second aspect or the first to the third possible implementations of the second aspect of this application, in a fourth possible implementation of the second aspect of this application, after the fastening a cable to the mating unit, the manufacturing method further includes: sleeving a housing on the mating unit, where a mating port and an insertion port are disposed on the housing, the cable passes through the insertion port, one end that is of the ground terminal and that is away from the cable is located in the mating port, and one end that is of the first signal terminal group and that is away from the cable is located in the mating port; and performing the injection molding to fasten the housing to the mating unit.

After the cable is fastened to the transmission part, the injection molding is performed to fasten the housing to the mating unit. This helps provide effective protection for connection points between terminals and corresponding conductors of the cable, and prolong a service life of the cable module.

According to a third aspect, this application further provides a circuit board assembly, including a circuit board and the foregoing cable module, where a transmission part of the cable module is electrically connected to the circuit board.

According to the third aspect, an electrical connection structure of a ground shielding part connects a plurality of ground terminals in series to form a mesh structure that is grounded together. This improves an electromagnetic shielding effect between first signal terminal groups, and improves crosstalk performance of the circuit board assembly. Therefore, quality of signal transmission between the circuit board assembly and another device is improved.

According to a fourth aspect, this application further provides an electronic device, including a first part and the foregoing cable module, where a transmission part of the cable module is electrically connected to the first part.

According to the fourth aspect, an electrical connection structure of a ground shielding part connects a plurality of ground terminals in series to form a mesh structure that is grounded together. This improves an electromagnetic shielding effect between first signal terminal groups, and improves crosstalk performance of the electronic device.

### BRIEF DESCRIPTION OF DRAWINGS

FIG. 1a is a schematic diagram of an application scenario of a cable module according to this application;

FIG. 1b is a schematic diagram of another application scenario of a cable module according to this application;

FIG. 2 is a schematic diagram of a partial structure of a cable module according to a first implementation of this application;

FIG. 3 is a three-dimensional schematic diagram of a partial structure of cable module according to a first implementation of this application;

FIG. 4a is a schematic diagram in which a mating unit is connected to a cable according to a first implementation of this application;

FIG. 4b is a three-dimensional schematic diagram of a partial area in which a mating unit is connected to a cable;

FIG. 5 is a schematic diagram of a mating unit according to a first implementation of this application;

FIG. 6 is a schematic diagram of a first preform according to a first implementation of this application;

FIG. 7a is a schematic diagram of a plurality of first signal terminal groups according to an implementation of this application;

FIG. 7b is a schematic diagram of a first signal terminal group according to an implementation of this application;

FIG. 7c is a side view of a first signal terminal according to an implementation of this application;

FIG. 8a is a schematic diagram of a ground shielding part according to an implementation of this application;

FIG. 8b is a top view of a partial structure of a ground shielding part according to an implementation of this application;

FIG. 8c is a side view of a partial structure of a ground shielding part according to an implementation of this application;

FIG. 9 is a schematic diagram of a first preform according to an implementation of this application;

FIG. 10 is a schematic diagram of a housing according to an implementation of this application;

FIG. 11a is a three-dimensional schematic diagram of a cable module according to an implementation of this application;

FIG. 11b is a three-dimensional schematic diagram of a cable module according to an implementation of this application;

FIG. 11c is a three-dimensional schematic diagram of a cable module according to an implementation of this application;

FIG. 12 is a flowchart of a cable module manufacturing method according to a first implementation of this application;

FIG. 13 is a flowchart of step S102 shown in FIG. 12 according to this application;

FIG. 14 is a flowchart of a cable module manufacturing method according to an implementation of this application;

FIG. 15 is a schematic diagram of a cable module according to a second implementation of this application;

FIG. 16 is a schematic diagram of a transmission part according to a second implementation of this application;

FIG. 17 is a schematic diagram of a ground shielding part and a functional terminal according to a second implementation of this application; and

FIG. 18 is a flowchart of a cable module manufacturing method according to a second implementation of this application.

### DESCRIPTION OF EMBODIMENTS

A cable module usually includes a cable and a printed circuit board (PCB). The PCB includes a pad and a gold finger. The pad is configured for conductor welding of the cable. The gold finger is configured to mate with a terminal in a female connector. However, a frequently-used PCB cable module has a problem of poor crosstalk performance. In addition, for a PCB manufactured by using a conventional PCB manufacturing process, a shape tolerance of the PCB, a width dimension tolerance between gold fingers, a location degree tolerance of the gold finger (PIN), and the like are large. Consequently, problems such as reduced contact stability easily occur when the cable module is interconnected with the female connector.

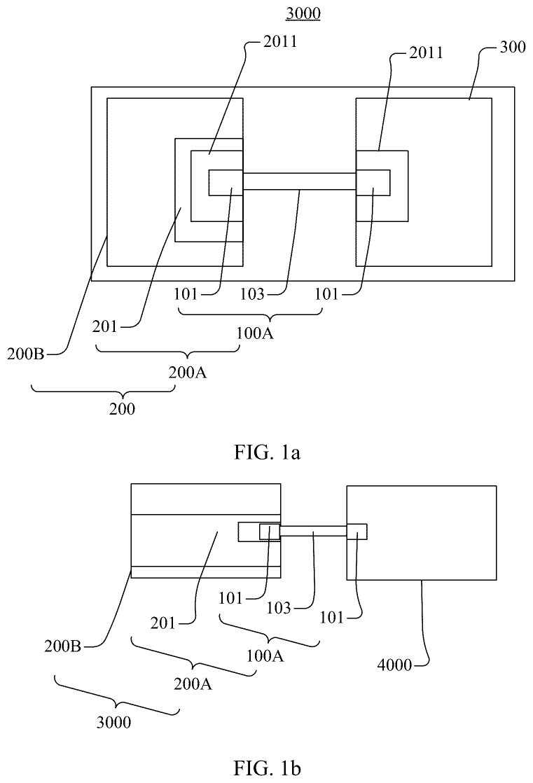

FIG. 1a is a schematic diagram of an application scenario of a cable module according to this application. An electronic device 3000 includes a first part 200 and a second part 300. The first part 200 includes a circuit board assembly 200A and a main housing 200B. The circuit board assembly 200A includes a circuit board 201 and a cable module 100A. The circuit board 201 is disposed on the main housing 200B. A female connector 2011 is disposed on the circuit board 201. One end of the cable module 100A may be pluggably connected and can be electrically connected to the female connector 2011, to implement an electrical connection between the cable module 100A and the circuit board 201. A female connector 2011 is disposed on the second part 300. The other end of the cable module 100A may be pluggably connected to the female connector 2011 of the second part 300. In other words, the cable module 100A is configured to connect the female connector 2011 of the first part 200 and the female connector 2011 of the second part 300, to implement signal transmission between the first part 200 and the second part 300.

The first part 200 and the second part 300 are different parts on a same electronic device. For example, the first part 200 is a mainboard on the electronic device 3000, and the second part 300 is a functional module on the electronic device 3000, to implement communication connection between different parts on the same electronic device 3000. The electronic device 3000 may be a computing device or a communication device, for example, a server, and the like. A type of the electronic device 3000 is not limited in this application.

The cable module 100A includes a male connector 101 and a cable 103 that are connected. The male connector 101 is configured to mate with the female connector 2011.

There are two male connectors 101. One male connector 101 is disposed at a first end of the cable 103, and the other male connector 101 is disposed at a second end of the cable 103.

A quantity of male connectors 101 in the cable module 100A is not limited in this application. In another implementation of this application, there may be a plurality of male connectors 101 in the cable module 100A. For example, the cable 103 may be divided into two or more branches. First ends of the plurality of branches are converged on a same male connector 101. A second end of each branch is equipped with one male connector 101. The male connector 101 may be detachably inserted into the female connector 2011 of the first part 200.

It may be understood that the cable module 100A may be electrically connected between different electronic devices, to implement communication connection between the different electronic devices. For example, FIG. 1b is a schematic diagram of another application scenario of a cable module according to this application. The electronic device 3000 includes the circuit board assembly 200A and the main housing 200B. The circuit board assembly 200A includes the circuit board 201 and the cable module 100A. The circuit board 201 is disposed on the main housing 200B. The cable module 100A is electrically connected to the circuit board 201. One end that is of the cable module 100A and that is away from the circuit board 201 is electrically connected to an external electronic device 4000, to implement signal transmission between the circuit board 201 and the external electronic device 4000.

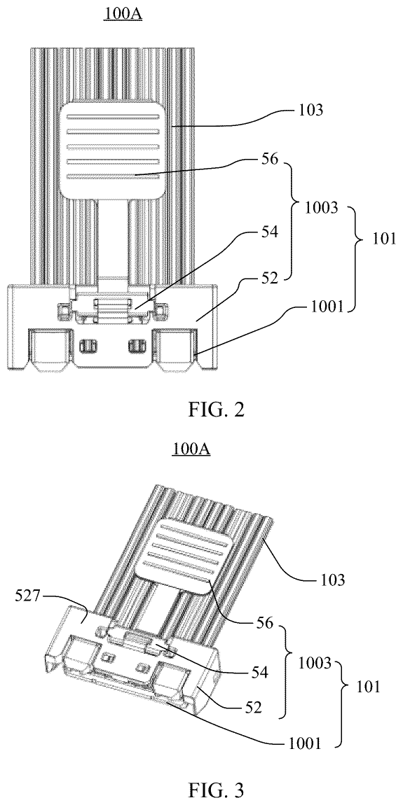

Refer to FIG. 2 and FIG. 3. The male connector 101 includes a mating unit 1001 and a housing 1003 that is fastened and sleeved on the mating unit 1001. In another implementation of this application, the housing 1003 may be omitted, and the mating unit 1001 may be detachably inserted into the female connector 2011. In another implementation of this application, an electronic device includes a circuit board assembly, where the circuit board assembly includes a circuit board and a cable module, the cable module includes a mating unit and a cable, and the mating unit and the circuit board can be electrically connected.

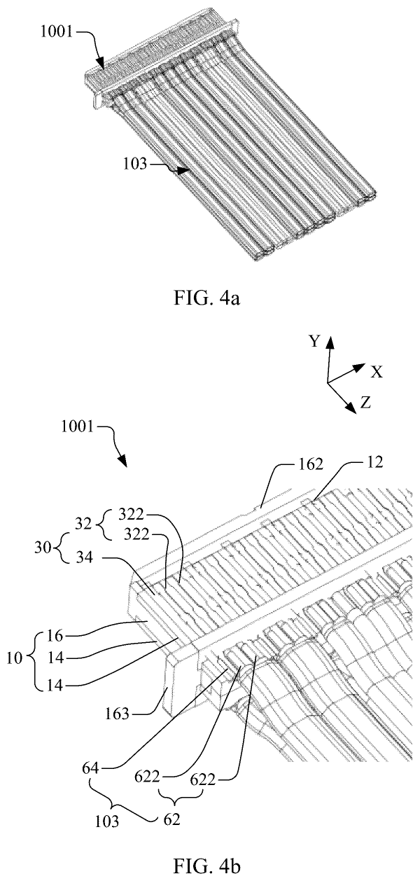

Refer to FIG. 4a and FIG. 4b. The mating unit 1001 includes a plastic substrate 10 and a transmission part 30 disposed on the plastic substrate 10, and is configured to be inserted into the female connector 2011 and interconnected with the female connector 2011.

The plastic substrate 10 is configured to bear the transmission part 30 and provide insulation protection for the transmission part 30. The plastic substrate 10 includes two surfaces 12 that are disposed opposite to each other. A material of the plastic substrate 10 is insulative plastics. The transmission part 30 is configured to be electrically connected to the female connector 2011.

In some implementations of this application, refer to FIG. 4b and FIG. 5. The plastic substrate 10 includes two first insulators 14 and one second insulator 16. The two first insulators 14 are fastened. Two times of injection molding are performed to form the first insulator 14 and the second insulator 16 respectively.

A surface that is of the first insulator 14 and that faces away from the second insulator 16 is a partial surface 12. The second insulator 16 covers at least a partial surface of the first insulator 14.

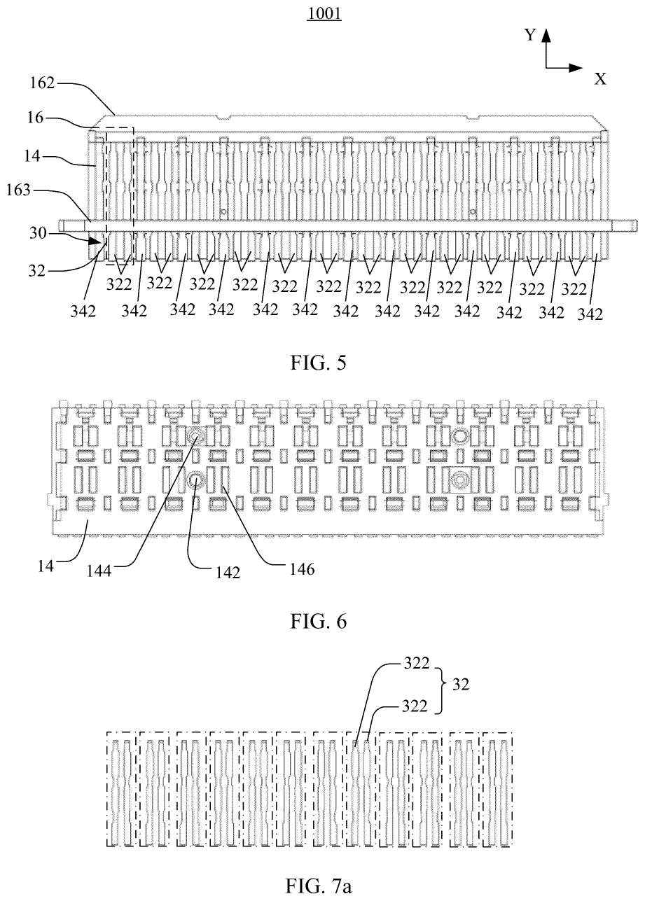

Refer to FIG. 6. A first snap-fit portion 142 and a second snap-fit portion 144 are disposed on a surface of each first insulator 14. In some implementations of this application, the first snap-fit portion 142 is a snap-fit hole, and the second snap-fit portion 144 is a protruding column. A first snap-fit portion 142 of the 1^{st} first insulator 14 is snapped to a second snap-fit portion 144 of the 2^{nd} first insulator 14, and a second snap-fit portion 144 of the 1^{st} first insulator 14 is fastened to a first snap-fit portion 142 of the second first insulator 14. Because the two first insulators 14 are fastened to each other, strength of the transmission part 30 is improved. A cavity 146 is further disposed in the first insulator 14, and is configured to adjust signal impedance, and the like.

Refer to FIG. 4b and FIG. 5 again. The second insulator 16 is connected between the two first insulators 14, so as to improve stability of a connection between the two first insulators 14, and improve overall strength of the mating unit 1001. A guide tongue portion 162 is formed at one end of the second insulator 16, to guide when the mating unit 1001 is inserted into the female connector. This facilitates mating between the mating unit 1001 and the female connector 2011. A limiting protrusion bar 163 is further disposed on the first insulator 14, and is configured to press against the housing 1003, to perform location fastening when the plastic substrate 10 and the housing 1003 are assembled.

In some implementations of this application, there are two transmission parts 30. Each transmission part 30 is disposed on the first insulator 14 of the plastic substrate 10 and is connected to the cable 103. The transmission part 30 includes a plurality of first signal terminal groups 32 and a ground shielding part 34 that are insulated from each other. The plurality of first signal terminal groups 32 are insulated from the ground shielding part 34 by using the first insulator 14 of the plastic substrate 10. The plurality of first signal terminal groups 32 are disposed on the surface 12 of the plastic substrate 10 at intervals. The plurality of first signal terminal groups 32 are configured to electrically contact first signal terminal groups in the female connector 2011, to implement signal transmission between the mating unit 1001 and the female connector 2011.

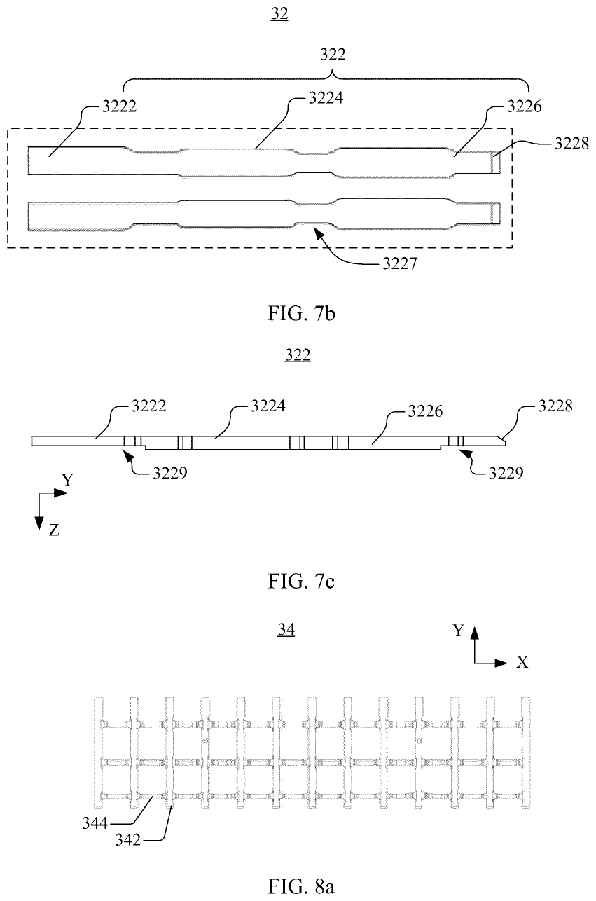

In some implementations of this application, a signal transmitted by the cable module 100A is a differential signal, to perform transmission of a high-speed signal (for example, PCIe 5.0). For example, scenarios shown in FIG. 5 and FIG. 7a are application scenarios of 24 pairs of high-speed signals (including 12TX 12RX). Each first signal terminal group 32 includes two first signal terminals 322. One first signal terminal 322 in each first signal terminal group 32 is a P terminal, and the other first signal terminal 322 in each first signal terminal group 32 is an N terminal. For each channel, a differential pair P/N includes two first signal terminals 322.

The plurality of first signal terminal groups 32 are arranged along a first direction (for example, an X direction shown in FIG. 4b and FIG. 5), and each first signal terminal 322 extends to be strip-shaped along a second direction (for example, a Y direction shown in FIG. 4b and FIG. 5) different from the first direction. The two first insulators 14 are stacked along a third direction. The third direction is different from the first direction. The Third direction is different from the second direction.

Refer to FIG. 7b. The first signal terminal 322 includes a pad portion 3222, a fastening portion 3224, and a mating portion 3226.

The pad portion 3222 is located on the tail of the first signal terminal 322, and is configured to be welded with the cable 103 by using a welding process. In some implementations of this application, the tail of the first signal terminal 322 is electroplated to form the pad portion 3222.

The fastening portion 3224 is connected between the pad portion 3222 and the mating portion 3226. A recess 3227 is provided on a side wall of each fastening portion 3224, and is configured to adjust signal impedance of the first signal terminal 322. For example, a part of the fastening portion 3224 shrinks inward along a radial direction to form the recess 3227.

The mating portion 3226 is configured to electrically contact a first signal terminal group in the female connector. In some implementations of this application, the head of the first signal terminal 322 is electroplated to form the mating portion 3226.

Refer to FIG. 7c. A bevel 3228 is disposed along a circumferential edge at one end that is of the mating portion 3226 and that is away from the pad portion 3222. The bevel 3228 is located on a side that is of the mating portion 3226 and that faces away from the inside of the plastic substrate 10. The second insulator 16 of the plastic substrate 10 covers the bevel 3228, to prevent warpage of the first signal terminal 322 relative to the plastic substrate 10, and help improve flatness of a surface that is of the mating unit 1001 and on which the first signal terminal 322 is disposed. Further, contact stability is improved when the mating unit 1001 of the cable module 100A is interconnected with the female connector 2011.

In some implementations of this application, in the third direction (for example, a Z direction shown in FIG. 7c), at least a partial thickness of the pad portion 3222 is less than a thickness of the fastening portion 3224, and at least a partial thickness of the mating portion 3226 is less than the thickness of the fastening portion 3224, to adjust the signal impedance. For example, a recess 3229 may be formed on a surface that is of the pad portion 3222 and that faces the plastic substrate 10, and on a surface that is of the mating portion 3226 and that faces the plastic substrate 10. The third direction is different from the first direction, and the third direction is different from the second direction. In another implementation of this application, at least a partial thickness of one of the pad portion 3222 and the mating portion 3226 is less than the thickness of the fastening portion 3224.

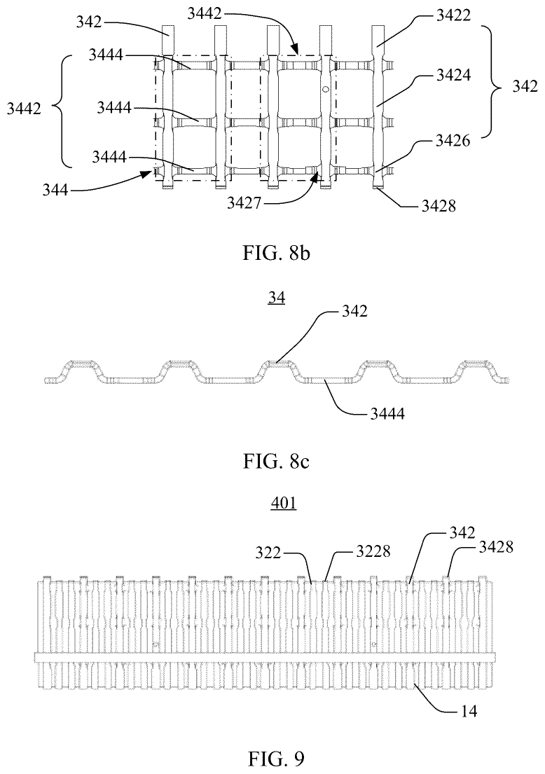

The ground shielding part 34 is configured to electromagnetically shield the plurality of first signal terminals 322. In some implementations of this application, copper alloy (for example, copper alloy plate or strip) stamping is performed to integrally form the ground shielding part 34. Refer to FIG. 4b, FIG. 5, and FIG. 8a. The ground shielding part 34 includes a plurality of ground terminals 342 and an electrical connection structure 344. It may be understood that a manufacturing process, a manner, and a material of the ground shielding part 34 are not limited in this application. In another implementation of this application, the first signal terminal 322 and the ground shielding part 34 of the transmission part 30 may be formed integrally or separately.

The plurality of ground terminals 342 are disposed on the surface 12 of the plastic substrate 10 at intervals, and are configured to electrically contact ground terminals in the female connector 2011. One first signal terminal group 32 (that is, two first signal terminals 322) is disposed between every two ground terminals 342, to electromagnetically shield the first signal terminals 322 in the first signal terminal group 32. The electrical connection structure 344 is embedded in the first insulator 14 of the plastic substrate 10. The electrical connection structure 344 is fastened and electrically connected to the plurality of ground terminals 342, to connect the plurality of ground terminals 342 in series to form an integrated mesh structure that is grounded together, so as to implement an effect that is similar to PCB vias being grounded together, and improve an electromagnetic shielding effect between the first signal terminal groups 32. Further, crosstalk performance of the cable module 100A is improved, and quality of signal transmission of the cable module 100A is improved.

In some implementations of this application, the plurality of ground terminals 342 are arranged along the first direction, and the ground terminal 342 extends to be strip-shaped along the second direction.

In some implementations of this application shown in FIG. 8b, a structure of the ground terminal 342 is approximately similar to a structure of the first signal terminal 322. Each ground terminal 342 includes a pad portion 3422, a fastening portion 3424, and a mating portion 3426.

The pad portion 3422 is configured to be welded with the cable 103 by using the welding process. In some implementations of this application, the tail of the ground terminal 342 is electroplated to form the pad portion 3422.

The fastening portion 3424 is connected between the pad portion 3422 and the mating portion 3426, and is configured to be fastened and electrically connected to the electrical connection structure 344. A recess 3427 is provided on a side wall of each fastening portion 3424, and is configured to adjust signal impedance of the ground terminal 342. For example, a part of the fastening portion 3424 shrinks inward along a radial direction to form the recess 3427. The recess 3427 may be implemented through rounding.

The mating portion 3426 is configured to electrically contact a ground terminal in the female connector 2011. In some implementations of this application, the head of the ground terminal 342 is electroplated to form the mating portion 3426. A bevel 3428 is disposed along a circumferential edge at one end that is of the mating portion 3426 and that is away from the pad portion 3422. The bevel 3428 is located on a side that is of the mating portion 3426 and that faces away from the inside of the plastic substrate 10. The second insulator 16 of the plastic substrate 10 covers the bevel 3428, to prevent warpage of the ground terminal 342 relative to the plastic substrate 10, and help improve flatness of a surface that is of the mating unit 1001 and on which the ground terminal 342 is disposed. Further, contact stability is improved when the mating unit 1001 of the cable module 100A is interconnected with the female connector 2011.

In some implementations of this application, in the third direction, at least a partial thickness of the pad portion 3422 is less than a thickness of the fastening portion 3424, and at least a partial thickness of the mating portion 3426 is less than the thickness of the fastening portion 3424, to adjust the signal impedance. For example, a recess may be formed on a surface that is of the pad portion 3422 and that is faces the plastic substrate 10, and on a surface that is of the mating portion 3426 and that faces the plastic substrate 10. In another implementation of this application, one of the partial thickness of the pad portion 3422 and the partial thickness of the mating portion 3426 is less than the thickness of the fastening portion 3424.

Refer to FIG. 8b and FIG. 8c. The electrical connection structure 344 includes a plurality of connection groups 3442 (in a dash-dotted-line box in FIG. 8b). Every two ground terminals 342 are fastened through one connection group 3442. In other words, each connection group 3442 is connected between the two ground terminals 342, so as to connect the two ground terminals 342 in series.

In some implementations of this application, each connection group 3442 includes a plurality of conductive connection parts 3444 arranged along the second direction at intervals. The conductive connection part 3444 is embedded in the first insulator 14 of the plastic substrate 10. One end of each conductive connection part 3444 is fastened to a fastening portion 3424 of one ground terminal 342, and the other end of each conductive connection part 3444 is fastened to a fastening portion 3424 of another ground terminal 342. In this way, a plurality of regular grids are formed in the ground shielding part 34. This facilitates manufacturing of the ground shielding part 34, and also facilitates dissipation of heat generated by terminals (including the first signal terminal 322, the ground terminal 342, and the like) in the cable module 100A.

In another implementation of this application, the structure of the ground terminal 342 is not limited, and a structure of the electrical connection structure 344 is not limited, for example, provided that the electrical connection structure 344 can connect a plurality of ground terminals 342 in series to form a mesh structure that is grounded together.

Refer to FIG. 2, FIG. 3, and FIG. 4b again, the housing 1003 is fastened and sleeved outside the plastic substrate 10, and is configured to protect the plastic substrate 10 and the transmission part 30 on the plastic substrate 10.

The housing 1003 includes a housing body 52, a latch 54, and a draw string 56.

The housing body 52 is fastened and sleeved on the plastic substrate 10. In some implementations of this application, injection molding is performed to fasten the housing body 52 to the plastic substrate 10, to enhance stability of a connection between the housing body 52 and the plastic substrate 10. The housing body 52 may be inserted into the female connector 2011.

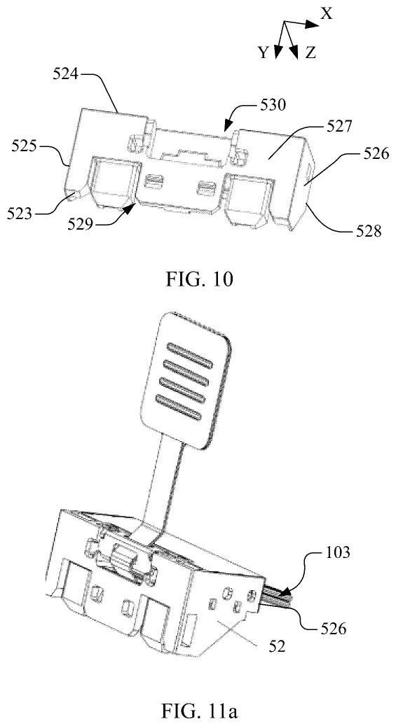

Refer to FIG. 10. The housing body 52 includes a first side surface 523, a second side surface 524, a third side surface 525, a fourth side surface 526, a fifth side surface 527, and a sixth side surface 528 that are connected. The first side surface 523 and the second side surface 524 are disposed opposite to each other along the second direction. The third side surface 525 and the fourth side surface 526 are disposed opposite to each other along the third direction. The fifth side surface 527 and the sixth side surface 528 are disposed opposite to each other along the first direction. One surface 12 of the plastic substrate 10 is disposed facing the third side surface 525, and another surface 12 of the plastic substrate 10 is disposed facing the fourth side surface 526.

A mating port 529 and an insertion port 530 is provided on the housing body 52. The mating port 529 runs through the first side surface 523, the third side surface 525, and the fourth side surface 526. The guide tongue portion 162 is disposed corresponding to the first side surface 523. The first signal terminal 322 and the ground terminal 342 may electrically contact a corresponding terminal of the female connector 2011 through the mating port 529.

The insertion port 530 is disposed on the second side surface 524, and is configured for the cable 103 to pass through. Because the insertion port 530 is disposed on the second side surface 524, the first side surface 523 and the second side surface 524 are disposed opposite to each other along the second direction, and length directions of the first signal terminal 322 and the ground terminal 342 are both along the second direction, the cable 103 enters the insertion port 530 in a straight-through manner, the cable 103 can be directly assembled with the transmission part 30 without being bent, and this facilitates assembly of the cable module 100A.

The latch 54 is disposed on the fifth side surface 527, and is configured to be snapped to a latch on the female connector, to reduce a possibility of an insecure connection when the mating unit 1001 is interconnected with the female connector.

The draw string 56 is disposed on the latch 54, and is configured to pull the latch 54, to facilitate unlocking between the latch 54 and the latch of the female connector.

The cable 103 passes through the insertion port 530. Refer to FIG. 4b again. The cable 103 includes a plurality of first signal conductors groups 62 that are insulated from each other and a plurality of ground conductors 64. Each first signal conductor group 62 includes two first signal conductors 622. One first signal conductor 622 in each first signal conductor group 62 is a P signal conductor, and the other first signal conductor 622 in each first signal conductor group 62 is an N signal conductor. Each P signal conductor is fastened through welding to the pad portion 3222 of a corresponding P terminal. Each P signal conductor is electrically connected to the corresponding P terminal. Each N signal conductor is fastened through welding to a pad portion 3222 (as shown in FIG. 7b) of a corresponding N terminal. In some implementations of this application, a hotbar technology may be used, but is not limited herein. Each N signal conductor is electrically connected to the corresponding N terminal. Each ground conductor 64 is fastened through welding to a pad portion 34222 (as shown in FIG. 8b) of a corresponding ground terminal 342. Each ground conductor 64 is electrically connected to the corresponding ground terminal 342.

A manner for fastening conductors of the cable 103 to terminals is not limited in this application, provided that the conductors of the cable 103 are electrically connected to the corresponding terminals.

In another implementation of this application, there may be one first signal terminal 322 in each first signal terminal group 32, and there may be one first signal conductor 622 in each first signal conductor group 62, to be applicable to a low-speed signal (for example, slower than a 3G signal) transmission scenario.

When the cable module 100A is produced, the copper alloy (for example, copper alloy plate or strip) stamping is firstly performed to form a plurality of first signal terminal groups 32 (as shown in FIG. 7a) and a ground shielding part 34 (as shown in FIG. 8a). The tail and the head of a preform of a signal terminal are electroplated to form the pad portion 3222 (as shown in FIG. 7c) and the mating portion 3226 (as shown in FIG. 7c). The tail and the head of the ground terminal 342 of a preform of a ground shielding part are electroplated to form the pad portion 3422 (as shown in FIG. 8b) and the mating portion 3426 (as shown in FIG. 8b), to complete manufacturing of the transmission part 30.

1^{st}-time injection molding is performed on the transmission part 30 (including the first signal terminal group 32 and the ground shielding part 34) to form a first preform 401 (as shown in FIG. 9). The first insulator 14 is formed by plastic that is injected when the first preform 401 is formed. In other words, the first preform 401 includes the first insulator 14 and the transmission part 30. The bevel 3428 of the first signal terminal 322 protrudes out of the first insulator 14, and the bevel 3428 of the ground terminal 342 protrudes out of the first insulator 14.

The two first preforms 401 are fastened in a snap-fit manner. 2^{nd}-time injection molding is performed on the two fastened first preforms to form the mating unit 1001 (as shown in FIG. 5). The second insulator 16 is formed by plastic that is injected when the mating unit 1001 is formed. The mating unit 1001 includes the first insulator 14, the second insulator 16, and the transmission part 30. The second insulator 16 covers the bevel 3228 of the first signal terminal 322 and the bevel 3428 of the ground terminal 342.

The first signal conductor 622 of the cable 103 is welded with the pad portion 3222 of the corresponding first signal terminal 322, and the ground conductor 64 is welded with the pad portion 3422 of the corresponding ground terminal 342, as shown in FIG. 4a and FIG. 4b.

As shown in FIG. 2 and FIG. 3, the housing 1003 is fastened and sleeved outside the mating unit 1001, and cables in the cable 103 pass through the insertion port 530.

3rd-time injection molding is performed on the housing 1003 and the mating unit 1001 to form the cable module 100A.

In a first implementation of this application, the cable module 100A is manufactured by using stamping, injection molding, and welding technologies, and replaces a conventional PCB cable module, and manufacturing precision of the cable module 100A is improved. For example, a width tolerance between terminals along the first direction is reduced, a shape width tolerance of the mating unit 1001 is reduced, and location precision of terminals in the mating unit 1001 is improved. Further, a possibility that terminals are connected in series (PINs are incorrectly connected in series or a short circuit occurs) when the mating unit 1001 is interconnected with the female connector 2011 is reduced, and reliability of using the cable module 100A is improved.

Because stamping is performed to form the transmission part 30 of the cable module 100A, and 3^{rd}-time injection molding is performed to form the cable module 100A, a thickness of the male connector 101 in the third direction can be reduced. This helps reduce occupied space of the mating unit 1001, and reduces manufacturing costs of the cable module 100A.

In addition, the cable module 100A manufactured by using the stamping, injection molding, and welding technologies simplifies a supply chain of the cable module 100A, eliminates a complex PCB molding process, and shortens a delivery cycle of the module.

In addition, structures including a cavity and a recess that can regulate the signal impedance are disposed in the mating unit 1001, to improve impedance consistency between single parts of the mating unit 1001.

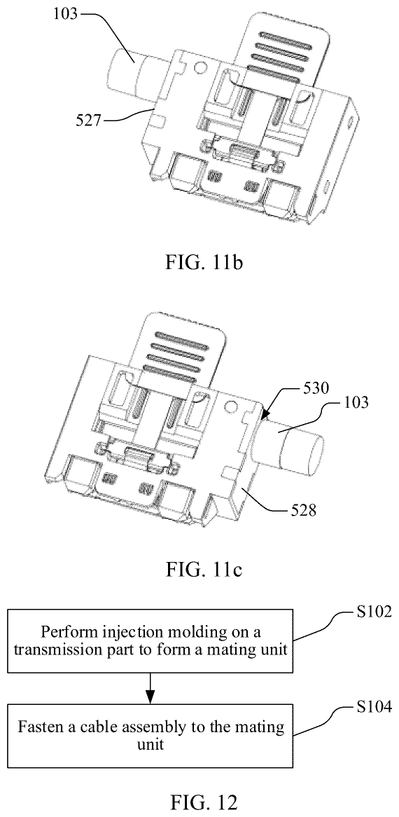

In another implementation of this application, the insertion port 530 may be disposed on another side surface of the housing body 52, to adapt to installation scenarios of different installation space, and improve wiring flexibility of the cable module 100A. For example, the insertion port of the housing body 52 may be disposed on the fourth side surface 526 (as shown in FIG. 11a), or the insertion port of the housing body 52 may be disposed on the fifth side surface 527 (as shown in FIG. 11b), or the insertion port of the housing body 52 may be disposed on the sixth side surface 528 (as shown in FIG. 11c), and the cables in the cable 103 need to be bent.

In another implementation of this application, the structure and the shape of the housing 1003 are not limited in this application.

In another implementation of this application, there may be one transmission part 30, and the first signal terminal 322 and the ground terminal 342 are disposed on one surface 12 of the plastic substrate 10. In other words, terminals are disposed on only one surface of the plastic substrate 10 of the male connector 101.

In another implementation of this application, a manufacturing process of the cable module 100A is not limited. For example, the transmission part 30 may be processed and molded by using a numerical control machine tool. One time of injection molding or more than two times of injection molding are performed to form the male connector 101.

A cable module 100A manufacturing method is further provided according to a first implementation of this application. Refer to FIG. 12. The method includes the following steps:

Step S102: Refer to FIG. 4b and FIG. 5. Perform injection molding on a transmission part 30 to form a mating unit 1001. The mating unit 1001 includes a plastic substrate 10 and a transmission part 30. Refer to FIG. 8a, FIG. 8b, and FIG. 8c, the transmission part 30 includes a plurality of first signal terminal groups 32 and a ground shielding part 34. The plurality of first signal terminal groups 32 are disposed on the plastic substrate 10 at intervals and protrude from a surface 12 of the plastic substrate 10. The ground shielding part 34 is insulated from the plurality of first signal terminal groups 32. The ground shielding part 34 includes a plurality of ground terminals 342 and an electrical connection structure 344. The plurality of ground terminals 342 are disposed on the plastic substrate 10 at intervals and protrude from the surface 12 of the plastic substrate 10. One first signal terminal group 32 is disposed between every two ground terminals 342, and the electrical connection structure 344 is embedded in the plastic substrate 10. The electrical connection structure 344 is fastened and electrically connected to the plurality of ground terminals 342, to connect the plurality of ground terminals 342 in series and form a mesh structure.

Step S104: Fasten the cable 103 to the mating unit 1001. The cable 103 includes a plurality of first signal conductor groups 62 and a plurality of ground conductors 64. Each first signal conductor group 62 is fastened and electrically connected to one first signal terminal group 32 correspondingly. Each ground conductor 64 is fastened and electrically connected to one end of one ground terminal 342.

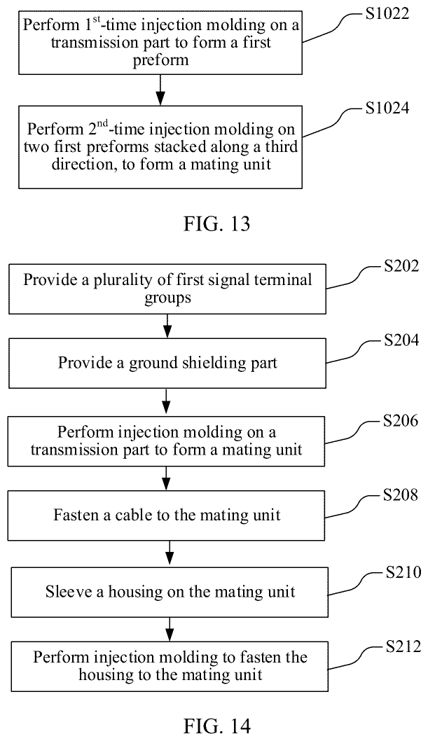

In the step S102, refer to FIG. 13. The performing injection molding on a transmission part 30 to form a mating unit 1001 includes the following steps:

Step S1022: Perform 1^{st}-time injection molding on the transmission part 30 to form a first preform 401 (as shown in FIG. 9), where the first preform 401 includes the transmission part 30 and a first insulator 14, a plurality of ground terminals 342 and a plurality of first signal terminal groups 32 are arranged on a surface of the first insulator 14 along a first direction, the length of the ground terminal 342 extends along a second direction different from the first direction, and the electrical connection structure 344 is embedded in the first insulator 14.

Step S1024: Perform 2^{nd}-time injection molding on two first preforms 401 stacked along a third direction, to form the mating unit 1001 (as shown in FIG. 5), where the mating unit 1001 includes two first insulators 14, one second insulator 16, and two transmission parts 30, the second insulator 16 is connected between the two first insulators 14, a plurality of ground terminals 342 and a plurality of first signal terminal groups 32 on each first insulator 14 are disposed on a surface that is of the first insulator 14 and that faces away from the other first insulator 14, the third direction is different from the first direction, and the third direction is different from the second direction. The second insulator 16 covers a bevel 3228 of the first signal terminal 322 and a bevel 3428 of the ground terminal 342. Refer to FIG. 6. A first snap-fit portion 142 and a second snap-fit portion 144 are disposed on each first insulator 14. A first snap-fit portion 142 of the 1^{st} first insulator 14 is snapped to a second snap-fit portion 144 of the 2^{nd} first insulator 14, and a second snap-fit portion 144 of the 1^{st} first insulator 14 is snapped to a first snap-fit portion 142 of the 2^{nd} first insulator 14, to fasten the two first preforms. A cavity 146 that can adjust signal impedance is further disposed in the first insulator 14. The cavity 146 may be further configured to mate with a die core during the injection molding, so as to improve injection molding precision.

In another implementation of this application, there may be one transmission part 30, and the injection molding is directly performed on the transmission part 30 to form the mating unit 1001.

A cable module 100A manufacturing method is further provided according to an implementation of this application. Refer to FIG. 14. The method includes the following steps:

Step 202: Provide a plurality of first signal terminal groups 32 (as shown in FIG. 7a). Each first signal terminal group 32 includes two first signal terminals 322. Copper alloy stamping may be performed to form a plurality of first signal terminal groups and a plurality of second signal terminals. The stamping may be performed to form the first signal terminal groups 32, to reduce manufacturing costs of the cable module 100A. In another implementation of this application, the plurality of first signal terminal groups 32 may be manufactured in another manner.

Step 204: Provide a ground shielding part 34 (as shown in FIG. 8a). The ground shielding part 34 includes a plurality of ground terminals 342 and an electrical connection structure 344. A transmission part 30 includes the ground shielding part 34 and the first signal terminal groups 32. The copper alloy stamping may be performed to form the ground shielding part 34, to reduce manufacturing costs of the cable module 100A. In another implementation of this application, the ground shielding part 34 may be manufactured in another manner.

Step 206: Perform injection molding on the transmission part 30 to form a mating unit 1001 (as shown in FIG. 5). The mating unit 1001 includes a plastic substrate 10 and a transmission part 30. The plurality of first ground terminals groups 32 are disposed on the plastic substrate 10 at intervals and protrude from a surface 12 of the plastic substrate 10. The ground shielding part 34 is insulated from the plurality of first signal terminal groups 32. The plurality of ground terminals 342 are disposed on the plastic substrate 10 at intervals and protrude from the surface 12 of the plastic substrate 10. One first signal terminal group 32 is disposed between every two ground terminals 342, and the electrical connection structure 344 is embedded in the plastic substrate 10. The electrical connection structure 344 is electrically connected to the plurality of ground terminals 342, to connect the plurality of ground terminals 342 in series and form a mesh structure.

Step S208: Fasten the cable 103 to the mating unit 1001 (as shown in FIG. 5). The cable 103 includes a plurality of first signal conductor groups 62 and a plurality of ground conductors 64. Each first signal conductor group 62 is fastened and electrically connected to one first signal terminal group 32 correspondingly. Each ground conductor 64 is fastened and electrically connected to one end of one ground terminal 342.

Step S210: Sleeve a housing 1003 on the mating unit 1001. A mating port 529 and an insertion port 530 are disposed on the housing 1003. The cable 103 passes through the insertion port 530. One end that is of the ground terminal 342 and that is away from the ground conductor 64 of the cable 103 is located in the mating port 529, and one end that is of the first signal terminal group 32 and that is away from the first signal conductor 622 of the cable 103 is located on the mating port 529.

Step S212: Perform injection molding to fasten the housing 1003 to the mating unit 1001. A male connector 101 includes the housing 1003 and the mating unit 1001.

After the cable 103 and the transmission part 30 are fastened, the injection molding is performed to fasten the housing 1003 to the mating unit 1001. This helps provide effective protection for connected points between terminals and corresponding conductors of the cable 103, and prolong a service life of the cable module 100A.

In another implementation of this application, the step 202 and the step 204 may be interchanged or performed in a synchronous manner.

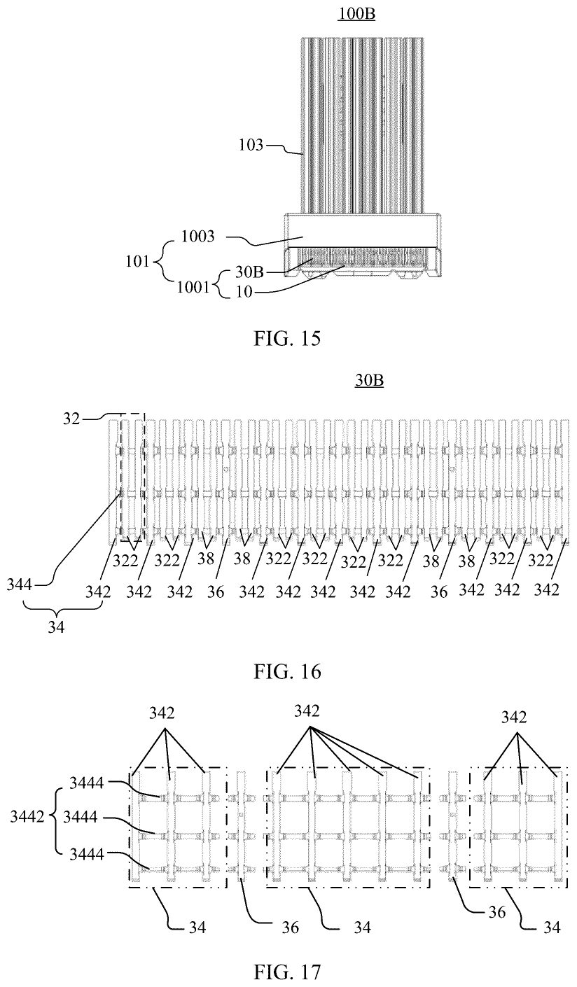

Refer to FIG. 15. A cable module 100B is provided according to a second implementation of this application. A structure of the cable module according to the second implementation is similar to a structure of the cable module 100A according to the first implementation. The cable module 100B includes a male connector 101 and a cable 103 that are connected. The male connector 101 includes a mating unit 1001 and a housing 1003 that is fastened and sleeved outside the mating unit 1001. The mating unit 1001 includes a plastic substrate 10 and a transmission part 30B embedded on the plastic substrate 10. A difference lies in a structure of the transmission part 30B.

Refer to FIG. 16. The transmission part 30B includes a first signal terminal group 32, a ground shielding part 34, a functional terminal 36, and a second signal terminal 38.

The first signal terminal group 32 includes two first signal terminals 322, and the two first signal terminals 322 are disposed between every two ground terminals 342 of each ground shielding part 34. Two first signal terminals 322 in each first signal terminal group 32 may transmit a differential signal pair. One first signal terminal 322 in each first signal terminal group 32 is a P terminal, and the other first signal terminal 322 in each first signal terminal group 32 is an N terminal. In other words, for each channel, a differential pair P/N includes two first signal terminals 322.

Copper alloy stamping may be performed to form a plurality of first signal terminal groups 32 that each include two first signal terminals 322 and a plurality of second signal terminals 38. It may be understood that a manufacturing process, a manner, and a material of the first signal terminal group 32 and the second signal terminal 38 are not limited in this application.

There may be a plurality of ground shielding parts 34. Each ground shielding part 34 includes a plurality of ground terminals 342 and an electrical connection structure 344.

One functional terminal 36 is disposed between every two adjacent ground shielding parts 34, and two second signal terminals 38 are disposed between each functional terminal 36 and an adjacent grounding terminal 342. The functional terminal 36 may transmit a power signal. The second signal terminal 38 may transmit a low-speed signal.

Copper alloy stamping may be performed to form a preformed mesh structure. The preformed mesh structure is cut to form a plurality of ground shielding parts 34 and a plurality of functional terminals 36 (as shown in FIG. 17), so as to simplify a manufacturing step of the transmission part 30B and reduce manufacturing costs of the transmission part 30B. It may be understood that a manufacturing process, a manner, and a material of the ground shielding part 34 and the functional terminal 36 are not limited in this application.

The cable 103 includes a plurality of first signal conductor groups, a plurality of functional signal conductors, and a plurality of second signal conductors. Each first signal conductor group includes two first signal conductors. A first signal conductor is electrically connected to the first signal terminal 322, and each functional signal conductor is electrically connected to one functional terminal 36 correspondingly. A second signal conductor is electrically connected to the second signal terminal 38. A signal transmission rate in the second signal conductor is lower than a transmission rate in the first signal conductor. The two first signal conductors can transmit a high-speed differential signal pair. The second signal conductor can transmit the low-speed signal, and the functional terminal 36 can transmit the power signal. In this way, a scenario in which the cable module may need to process the differential signal pair/the low-speed signal/the power signal. For example, an example scenario in FIG. 16 is an application scenario of 16 pairs of high-speed signals (8RX 8TX) and 16 low-speed signals.

It may be understood that, types of signals transmitted by the first signal terminal group 32, the second signal terminal 38, and the functional terminal 36 are not limited in this application, and the functional terminal 36 may alternatively be omitted.

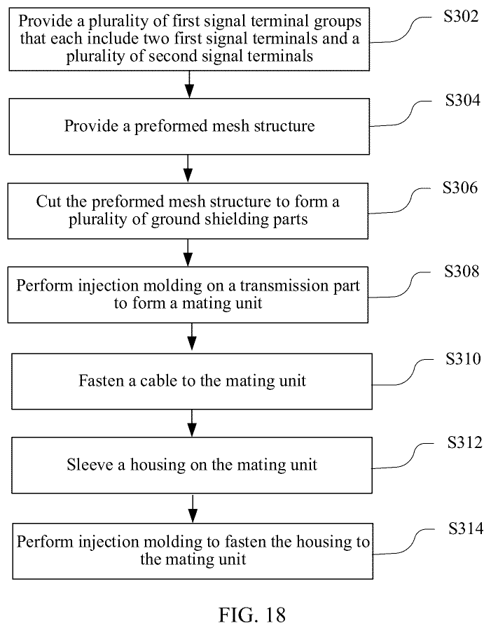

Refer to FIG. 18. A cable module 100B manufacturing method is further provided according to a second implementation of this application, including the following steps:

Step 302: Refer to FIG. 16. Provide a plurality of first signal terminal groups 32 that each include two first signal terminals 322 and a plurality of second signal terminals 38, where one first signal terminal 322 in each first signal terminal group 32 is a P terminal, and the other first signal terminal 322 in each first signal terminal group 32 is an N terminal.

In this implementation, copper alloy stamping is performed to form a plurality of first signal terminal groups 32 that each include two first signal terminals 322 and a plurality of second signal terminals 38, so as to reduce manufacturing costs of preparing the cable module 100B.

Step 304: Provide a preformed mesh structure. In this implementation, the copper alloy stamping is performed to form the preformed mesh structure, to simplify a manufacturing step of the cable module 100B and reduce preparation costs of the cable module 100B.

Step 306: Refer to FIG. 17. Cut the preformed mesh structure to form a plurality of ground shielding parts 34. In this implementation, the cutting the preformed mesh structure to form a plurality of ground shielding parts 34 includes: cutting the preformed mesh structure to form the plurality of ground shielding parts 34 and a plurality of functional terminals 36.

Step 308: Perform injection molding on a transmission part 30B to form a mating unit 1001.

The transmission part 30B includes the first signal terminal group 32, the plurality of ground shielding parts 34, the plurality of functional terminals 36, and the plurality of second signal terminals 38.

In some implementations of this application, step 308 of performing injection molding on a transmission part 30 to form a mating unit 1001 includes: disposing one first signal terminal group 32 between every two ground terminals 342 of each ground shielding part 34, disposing one functional terminal 36 between every two adjacent ground shielding parts 34, and disposing two second signal terminals 38 between each functional terminal 36 and an adjacent ground terminal 342.

Step 310: Refer to FIG. 15. Fasten the cable 103 to the mating unit 1001.

The cable 103 includes a plurality of first signal conductor groups, a ground conductor, a plurality of function signal conductors, and a plurality of second signal conductors. Each first signal conductor group includes two first signal conductors. One first signal conductor in each first signal conductor group is a P signal conductor, and the other first signal conductor in each first signal conductor group is an N signal conductor.

Step 310 of fastening the cable 103 to the mating unit 1001 includes fastening and electrically connecting each ground conductor to one ground terminal 342 correspondingly, fastening and electrically connecting each functional signal conductor to one functional terminal 36 correspondingly, fastening and electrically connecting a first signal conductor to a corresponding first signal terminal 322, and fastening and electrically connecting a second signal conductor to a corresponding second signal terminal 38. In this implementation, the ground conductor is fastened to a pad portion of the ground terminal 342 through welding, the functional signal conductor is fastened to a pad portion of the functional terminal 36 through welding, the first signal conductor is fastened to a pad portion of the first signal terminal 322 through welding, and the second signal conductor is fastened to a pad portion of the second signal terminal 38 through welding.

Step S312: Sleeve a housing 1003 on the mating unit 1001. A mating port 529 and an insertion port 530 are disposed on the housing 1003. The cable 103 passes through the insertion port 530. One end that is of the ground terminal 342 and that is away from a ground conductor 64 of the cable 103 is located in the mating port 529, and one end that is of the first signal terminal group 32 and that is away from a first signal conductor 622 of the cable 103 is located on the mating port 529.

Step S314: Perform injection molding to fasten the housing 1003 to the mating unit 1001. The housing 1003 and the mating unit 1001 jointly form a male connector 101.

Direction terms mentioned in embodiments of this application, for example, “up”, “down”, “front”, “back”, “left”, “right”, “inside”, “outside”, “side face”, and the like, are merely directions that are based on the accompanying drawings. Therefore, the direction terms are used to better and more clearly describe and understand this application, instead of indicating or implying that a specified apparatus or element needs to have a specific direction, and be constructed and operated in the specific direction. Therefore, this cannot be understood as a limitation on embodiments of this application.

In addition, in this specification, sequence numbers, such as “first” and “second”, of components are merely intended to distinguish between the described objects, and do not have any sequential or technical meaning. “Connection” in this application includes direct connection and indirect connection unless otherwise specified.

The foregoing descriptions are merely specific implementations of this application, but are not intended to limit the protection scope of this application. Any variation or replacement readily figured out by a person skilled in the art within the technical scope disclosed in this application shall fall within the protection scope of this application. Therefore, the protection scope of this application shall be subject to the protection scope of the claims.

1. A cable module, comprising:
a mating unit, comprising:
a plastic substrate; and
a transmission part, comprising:
a plurality of first signal terminal groups, disposed on a surface of the plastic substrate at intervals; and
a ground shielding part, insulated from the plurality of first signal terminal groups, wherein the ground shielding part comprises a plurality of ground terminals and an electrical connection structure, the plurality of ground terminals are disposed on the surface of the plastic substrate at intervals, one first signal terminal group is disposed between every two ground terminals, the electrical connection structure is embedded in the plastic substrate, and the electrical connection structure is fastened and electrically connected to the plurality of ground terminals such that the plurality of ground terminals are connected via the electrical connection structure in series to form a mesh structure; and
a cable, comprising a plurality of first signal conductor groups and a plurality of ground conductors, wherein each ground conductor is electrically connected to one ground terminal correspondingly, and each first signal conductor group is electrically connected to one first signal terminal group correspondingly.

2. The cable module according to claim 1, wherein the electrical connection structure comprises a plurality of connection groups, the plurality of ground terminals are arranged along a first direction, a length of the ground terminal extends along a second direction different from the first direction, every two ground terminals are fastened through one connection group, each connection group comprises a plurality of conductive connection parts that are arranged along the second direction at intervals, and each conductive connection part is connected between the two ground terminals.

3. The cable module according to claim 2, wherein each ground terminal comprises a pad portion, a fastening portion, and a mating portion, the fastening portion is connected between the pad portion and the mating portion, the pad portion and a corresponding ground conductor are welded and electrically connected, each conductive connection part is fastened between fastening portions of the two ground terminals, a recess is provided on a side wall of the fastening portion, and a side wall of the recess is fastened to the conductive connection part.

4. The cable module according to claim 3, wherein in a third direction, at least a partial thickness of the pad portion is less than a thickness of the fastening portion, and/or at least a partial thickness of the mating portion is less than the thickness of the fastening portion, the third direction is different from the first direction, and the third direction is different from the second direction.

5. The cable module according to claim 3, wherein the ground terminal further comprises a bevel, the bevel is disposed on a circumferential edge that is of the mating portion and that faces away from the pad portion, the bevel is located on a side that is of the mating portion and that faces away from an inside of the plastic substrate, and the plastic substrate covers the bevel.

6. The cable module according to claim 1, wherein a cavity is provided inside the plastic substrate.

7. The cable module according to claim 1, wherein each first signal terminal group comprises two first signal terminals; and
each first signal conductor group comprises two first signal conductors, and each first signal conductor is electrically connected to a corresponding first signal terminal.

8. The cable module according to claim 1, wherein there are a plurality of ground shielding parts.

9. The cable module according to claim 8, wherein each first signal terminal group comprises two first signal terminals, and the transmission part further comprises a second signal terminal;
the transmission part further comprises a plurality of functional terminals, one functional terminal is disposed between every two adjacent ground shielding parts, and two second signal terminals are disposed between each functional terminal and an adjacent ground terminal;
the cable further comprises a plurality of functional signal conductors and a plurality of second signal conductors, and each functional signal conductor is electrically connected to one functional terminal correspondingly; and
each first signal conductor group comprises two first signal conductors, each first signal conductor is electrically connected to a corresponding first signal terminal, and each second signal conductor is electrically connected to a corresponding second signal terminal.

10. The cable module according to claim 1, wherein the plurality of ground terminals are arranged along a first direction, a length of the ground terminal extends along a second direction different from the first direction, there are two transmission parts, the two transmission parts are stacked along a third direction, the third direction is different from the first direction, and the third direction is different from the second direction;
the plastic substrate comprises two first insulators and one second insulator that are connected;
the second insulator is located between the two first insulators along the third direction; and
the electrical connection structure of each transmission part is embedded in the first insulator, and the ground terminals and the first signal terminal groups of each transmission part protrude from a surface that is of the first insulator and that faces away from the second insulator.

11. The cable module according to claim 10, wherein a first snap-fit portion and a second snap-fit portion are disposed on each first insulator; and
a first snap-fit portion of the 1^{st} first insulator is snapped to a second snap-fit portion of the 2^{nd} second insulator, and a second snap-fit portion of the 1^{st} first insulator is snapped to a first snap-fit portion of the 2^{nd} first insulator.

12. The cable module according to claim 1, wherein the cable module further comprises a housing, and the housing is fastened and sleeved outside the plastic substrate; and
a limiting protrusion bar is disposed on the surface of the plastic substrate, and the housing presses against the limiting protrusion bar.

13. A cable module manufacturing method, comprising:
performing injection molding on a transmission part to form a mating unit, wherein the mating unit comprises the transmission part and a plastic substrate, the transmission part comprises a plurality of first signal terminal groups and a ground shielding part, the plurality of first signal terminal groups are disposed on a surface of the plastic substrate at intervals, the ground shielding part is insulated from the plurality of first signal terminal groups, the ground shielding part comprises a plurality of ground terminals and an electrical connection structure, the plurality of ground terminal are disposed on the surface of the plastic substrate at intervals, one first signal terminal group is disposed between every two ground terminals, the electrical connection structure is embedded in the plastic substrate, and the electrical connection structure is fastened and electrically connected to the plurality of ground terminals such that the plurality of ground terminals are connected via the electrical connection structure in series to form a mesh structure; and
fastening a cable to the mating unit, wherein the cable comprises a plurality of ground conductors and a plurality of first signal conductor groups, each ground conductor is electrically connected to one end of the ground terminal correspondingly, and each first signal conductor group is electrically connected to one first signal terminal group correspondingly.

14. The cable module manufacturing method according to claim 13, wherein the performing injection molding on the transmission part to form the mating unit comprises:
performing 1^{st}-time injection molding on the transmission part to form a first preform, wherein the first preform comprises the transmission part and a first insulator, the plurality of ground terminals and the plurality of first signal terminal groups are arranged on a surface of the first insulator along a first direction, a length of the ground terminal extends along a second direction different from the first direction, and the electrical connection structure is embedded in the first insulator; and
performing 2^{nd}-time injection molding on two first preforms stacked along a third direction, to form the mating unit, wherein the mating unit comprises two first insulators, one second insulator, and two transmission parts, the second insulator is connected between the two first insulators, a plurality of ground terminals and a plurality of first signal terminal groups on each first insulator are disposed on a surface that is of the first insulator and that faces away from the other first insulator, the third direction is different from the first direction, and the third direction is different from the second direction.

15. The cable module manufacturing method according to claim 13, wherein the first signal terminal group comprises two first signal terminals, and before the performing injection molding on a transmission part to form a mating unit, the manufacturing method further comprises:
providing a plurality of first signal terminal groups and a plurality of second signal terminals;
providing a preformed mesh structure; and
cutting the preformed mesh structure to form a plurality of ground shielding parts.

16. The cable module manufacturing method according to claim 15, wherein the cable further comprises a plurality of functional signal conductors;
wherein the cutting the preformed mesh structure to form the plurality of ground shielding parts comprises: cutting the preformed mesh structure to form the plurality of ground shielding parts and a plurality of power terminals;
wherein the performing injection molding on the transmission part to form the mating unit comprises: disposing one functional terminal between every two adjacent ground shielding parts, and disposing two second signal terminals between each functional terminal and an adjacent ground terminal; and
wherein the fastening the cable to the mating unit comprises: electrically connecting each functional signal conductor to one functional terminal correspondingly, wherein a plurality of signal conductors comprise a first signal conductor and a second signal conductor, electrically connecting the first signal conductor to a corresponding first signal terminal, and electrically connecting the second signal conductor to a corresponding second signal terminal.

17. The cable module manufacturing method according to claim 15, wherein the providing the plurality of first signal terminal groups and the plurality of second signal terminals comprises: performing copper alloy stamping to form the plurality of first signal terminal groups and the plurality of second signal terminals, and the providing a preformed mesh structure comprises performing the copper alloy stamping to form the preformed mesh structure.

18. The cable module manufacturing method according to claim 13, wherein after the fastening the cable to the mating unit, the manufacturing method further comprises:
sleeving a housing on the mating unit, wherein a mating port and an insertion port are disposed on the housing, the cable passes through the insertion port, one end that is of the ground terminal and that is away from the cable is located in the mating port, and one end that is of the first signal terminal group and that is away from the cable is located in the mating port; and
performing the injection molding to fasten the housing to the mating unit.

19. A circuit board assembly, comprising a circuit board and a cable module, wherein a transmission part of the cable module is electrically connected to the circuit board; wherein the cable module comprises:
a mating unit, comprising:
a plastic substrate; and
a transmission part, comprising:
a plurality of first signal terminal groups, disposed on a surface of the plastic substrate at intervals; and
a ground shielding part, insulated from the plurality of first signal terminal groups, wherein the ground shielding part comprises a plurality of ground terminals and an electrical connection structure, the plurality of ground terminals are disposed on the surface of the plastic substrate at intervals, one first signal terminal group is disposed between every two ground terminals, the electrical connection structure is embedded in the plastic substrate, and the electrical connection structure is fastened and electrically connected to the plurality of ground terminals such that the plurality of ground terminals are connected via the electrical connection structure in series to form a mesh structure; and
a cable, comprising a plurality of first signal conductor groups and a plurality of ground conductors, wherein each ground conductor is electrically connected to one ground terminal correspondingly, and each first signal conductor group is electrically connected to one first signal terminal group correspondingly.
